(19) United States
(12) Patent Application Publication
(10) Pub. No.: US 2012/0249519 A1
(43) Pub. Date: Oct. 4, 2012

(54) DUMMY PIXELS MADE INACTIVE

(75) Inventor: William J. Cummings, San Jose, CA (US)

(73) Assignee: QUALCOMM MEMS TECHNOLOGIES, INC., San Diego, CA (US)

(21) Appl. No.: 13/074,799

(22) Filed: Mar. 29, 2011

(51) Int. Cl. G09G 3/32; G06F 3/038

(52) U.S. Cl. 345/214; 345/82

(57) ABSTRACT

This disclosure provides systems, methods and apparatus, including computer programs encoded on computer storage media, for preventing the edge subpixels of a display from actuating. Some implementations provide a small conductive via inside edge subpixels of a passively-addressed display, such as a microelectromechanical systems (MEMS)-based display. The vias may be configured to make an electrical connection between a movable conductive layer and another conductive layer of the edge subpixel. Electricity may be provided to the active subpixel array by way of these vias in the edge subpixels. The concepts provided herein apply to other types of passively-addressed displays, such as organic light-emitting diode (“OLED”) displays and field emission displays.

### TECHNICAL FIELD

This disclosure relates to display devices, including but not limited to display devices that incorporate electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

In many displays, pixels are made uniform throughout the display except at the edge. The same basic masks, processes, etc., are generally used to make all other pixels. However, edge pixels are treated differently. Edge pixels are the only pixels in an array that do not have the same types of structures on both sides.

In general, these edge pixels are not used as part of the “active area” of pixels that is used for the display. In some pixel arrays, photo-resist or black mask material may be used to obscure the edge pixels. Some edge pixels may draw power, move, etc., even though they are not part of the active display area.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a small conductive via inside edge subpixels of a passively-addressed display, such as a MEMS-based display. The vias may be configured to make an electrical connection between a movable conductive layer and another conductive layer of the edge subpixel. The vias can prevent the edge subpixels from actuating. The wiring into the active area of the array may pass through the edge pixel by way of these vias in the edge subpixels.

Various implementations of display devices are described herein. Some of these display devices include passively-addressed displays. Some such display devices include a routing area, an active subpixel array and an edge subpixel array. The active subpixel array may include rows and columns of active subpixels. The edge subpixel array may include rows and columns of edge subpixels configured to provide electrical connectivity between the routing area and the active subpixels. Each of the edge subpixels and the active subpixels may include a first conductive layer and a second conductive layer. At least one of the edge subpixels in each row or column also may include a via configured to provide electrical connectivity between the first conductive layer and the second conductive layer.

Each of the edge subpixels and the active subpixels may include a plurality of posts disposed between the first conductive layer and the second conductive layer. The vias may be disposed proximate the posts. Alternatively, a via may be formed in at least one of the posts in each row and column of edge subpixels.

The second conductive layer of each active subpixel may be configured to be movable relative to the first conductive layer when a sufficient voltage is applied between the first conductive layer and the second conductive layer. The second conductive layer may be formed, at least in part, of a reflective material. The edge subpixels and the active subpixels may include electromechanical systems (“EMS”)-based devices. The display may be an organic light-emitting diode (“OLED”) display or a field emission display.

The first conductive layer may be configured to provide electrical connectivity between a row or a column of active subpixels. The second conductive layer may be configured to provide electrical connectivity between a row or a column of active subpixels.

The display device may include a processor that is configured to communicate with the display and a memory device that is configured to communicate with the processor. The processor may be configured to process image data. The display device may include a driver circuit configured to send at least one signal to the display and a controller configured to send at least a portion of the image data to the driver circuit. The display device may include an input device configured to receive input data and to communicate the input data to the processor.

The display device may include an image source module configured to send the image data to the processor. The image source module may include a receiver, a transceiver and/or a transmitter.

Various methods are also described herein. Some such methods involve forming an optical stack, including a first conductive layer, over a substrate, forming a plurality of support structures on the optical stack or on the substrate and forming a second conductive and reflective layer on the support structures. The methods may involve forming an array of active subpixels that include the first conductive layer, the support structures and the second conductive layer such that the second conductive and reflective layer is movable between a first position and a second position when a voltage is applied to the active subpixels.

The methods may involve forming routing area outside the array of active subpixels and forming an edge subpixel array including rows and columns of edge subpixels. The edge subpixels may be configured to provide electrical connectivity between the routing area and the active subpixels. Each of the edge subpixels may include the first conductive layer, the second and reflective conductive layer and the support structures. At least one of the edge subpixels in each row or column may include a via configured to provide electrical connectivity between the first conductive layer and the second conductive and reflective layer.

The methods may involve isolating the first conductive layer or the second conductive and reflective layer of adjacent edge subpixels. The process of forming the edge subpixel array may include forming the vias in the support structures of the edge subpixels. The process of forming the edge subpixel array may involve forming the vias proximate the support structures of the edge subpixels. The process of forming the edge subpixel array may include forming a via in each edge subpixel. The second conductive and reflective layer of the edge subpixels may not be configured to be movable when the edge subpixels provide electrical connectivity between the routing area and the active subpixels.

Various alternative implementations of display devices are described herein, some of which include passively-addressed displays. These display devices may include routing apparatus, active subpixel apparatus and edge subpixel apparatus. The active subpixel apparatus may include a first conductive layer and a second conductive layer. The second conductive layer may be formed, at least in part, from reflective material. The active subpixel apparatus may include apparatus for controlling an optical cavity by moving the second conductive layer from a first position to a second position. The edge subpixel apparatus may be configured for providing electrical connectivity between the routing apparatus. The edge subpixel apparatus also may be configured for providing electrical connectivity between the first conductive layer and the second conductive layer.

The edge subpixel apparatus and the active subpixel apparatus may include a plurality of posts disposed between the first conductive layer and the second conductive layer. The apparatus for providing electrical connectivity between the first conductive layer and the second conductive layer may include a via formed in at least one of the posts in each row and column of edge subpixels. The first conductive layer may be configured to provide electrical connectivity between a row or a column of active subpixels.

The edge subpixel apparatus and the active subpixel apparatus may include electromechanical systems (“EMS”)-based devices. The display may be an organic light-emitting diode (“OLED”) display or a field emission display.

Details of one or more implementations of the subject matter described in this specification are set forth in the accompanying drawings and the description below. Although the examples provided in this summary are primarily described in terms of MEMS-based displays, the concepts provided herein apply to other types of passively-addressed displays, such as organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a display that includes an edge subpixel array having vias as provided herein.

FIG. 10A shows an example of an isometric view depicting two adjacent subpixels in an IMOD display device.

FIG. 10B shows an example of a flow diagram illustrating a process of fabricating displays according to some implementations provided herein.

FIG. 11 shows an example of a flow diagram illustrating a process of fabricating displays according to alternative implementations provided herein.

FIGS. 12A through 16C show examples of cross-sections through a subpixel array and routing elements during various stages in the process outlined in FIG. 11.

FIGS. 17A through 17F show examples of various layers that may be used for routing in edge subpixels and active area subpixels.

FIGS. 18A and 18B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some edge pixels may draw power, move, etc., even though they are not part of the active display area. For example, some displays actively drive the edge pixels using a separate drive scheme from that of the pixels in the active display area. Driving the edge pixels in this manner wastes power and adds complexity.

According to some implementations provided herein, edge subpixels of passively-addressed displays are inactive “dummy” subpixels. Some such implementations are made inactive by including a via in each of the edge subpixels, whereas other implementations are made inactive by including at least one via in each subpixel row or column. The edge subpixel vias electrically connect a first conductive layer with a second conductive layer. The active subpixels are driven by applying a voltage between the first conductive layer with the second conductive layer. Because the vias electrically connect the first conductive layer with the second conductive layer of the edge subpixels, the edge subpixels are not actuated when the active subpixels are driven, because no potential difference is created between the first conductive layer and the second conductive layer of the edge subpixels.

Particular implementations of the subject matter described in this disclosure can be implemented to realize one or more of the following potential advantages. Because the vias cause the edge subpixels to become inactive, the edge subpixels do not draw power and do not require a separate drive scheme. Therefore, displays that include edge subpixels as described herein may be more energy efficient and may be somewhat simpler to operate. After the vias are included, the edge subpixels may become slightly more conductive than edge subpixels without such vias. The edge subpixels may, in effect, become part of the routing. In addition, the visual appearance of the edge subpixels can be independent of the driving voltages in the active array and therefore the edge subpixels may be suitable to use as a uniform view area border of the display. In some drive schemes, it is not possible to predict the behavior of ordinary subpixels that are not fully addressed (valid waveforms on both row and column). Various implementations described herein obviate the requirement of having extra driver outputs to control the visual appearance of the edge subpixels.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

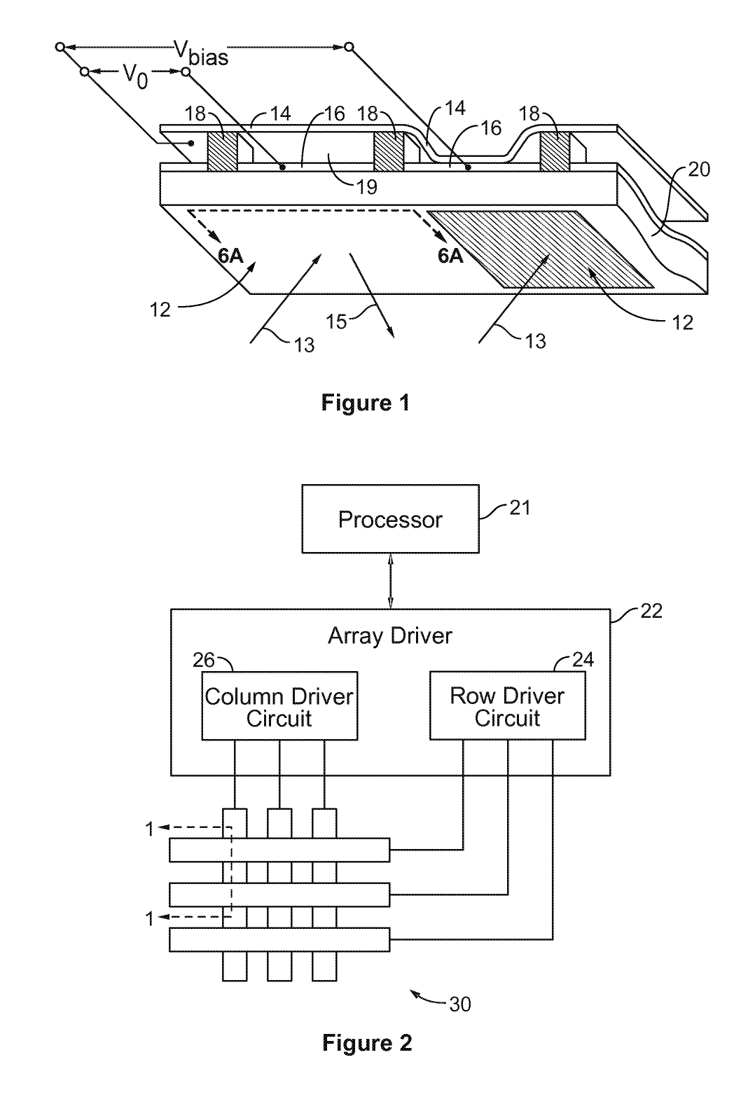

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

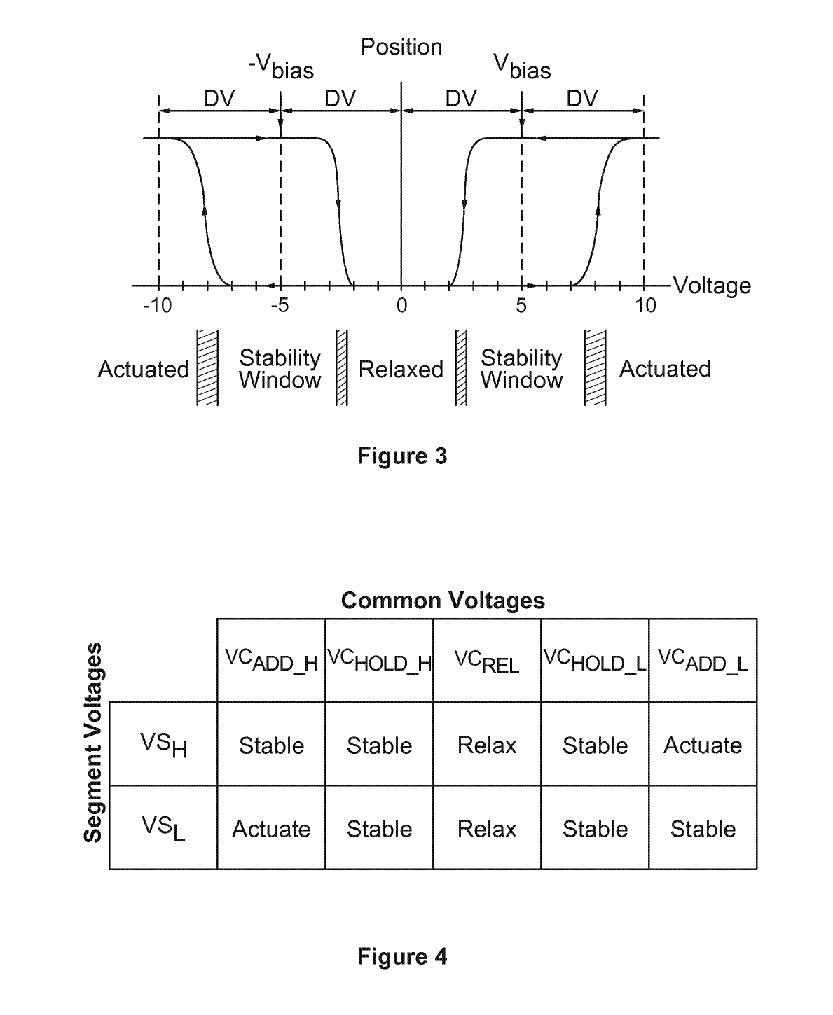

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

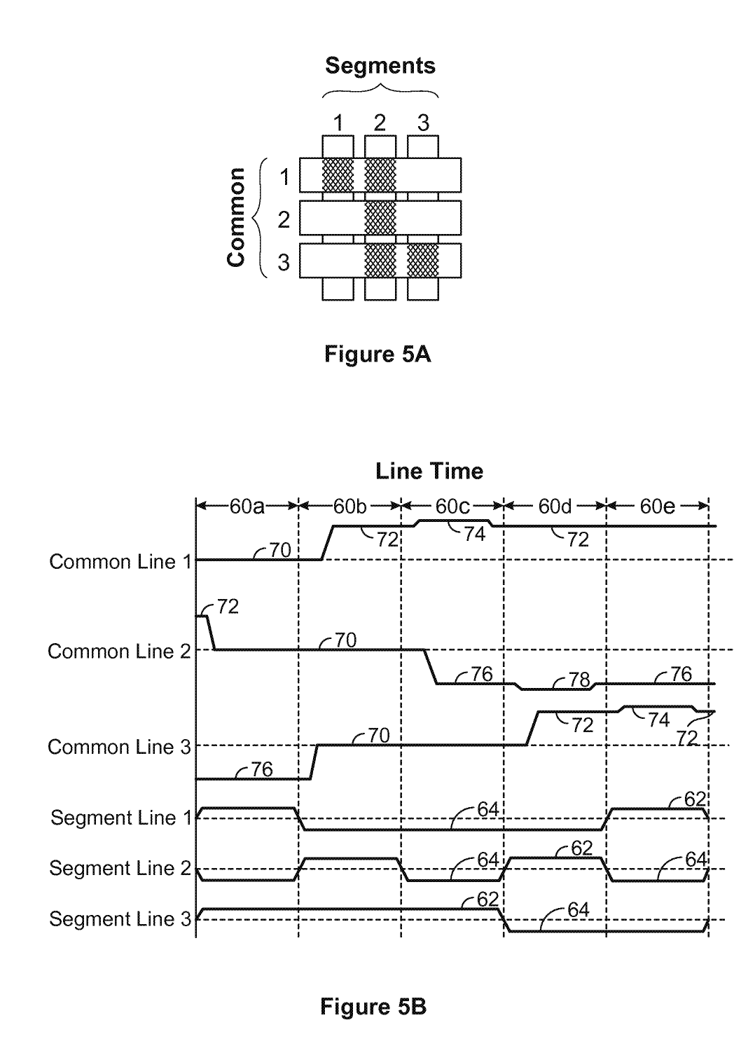

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

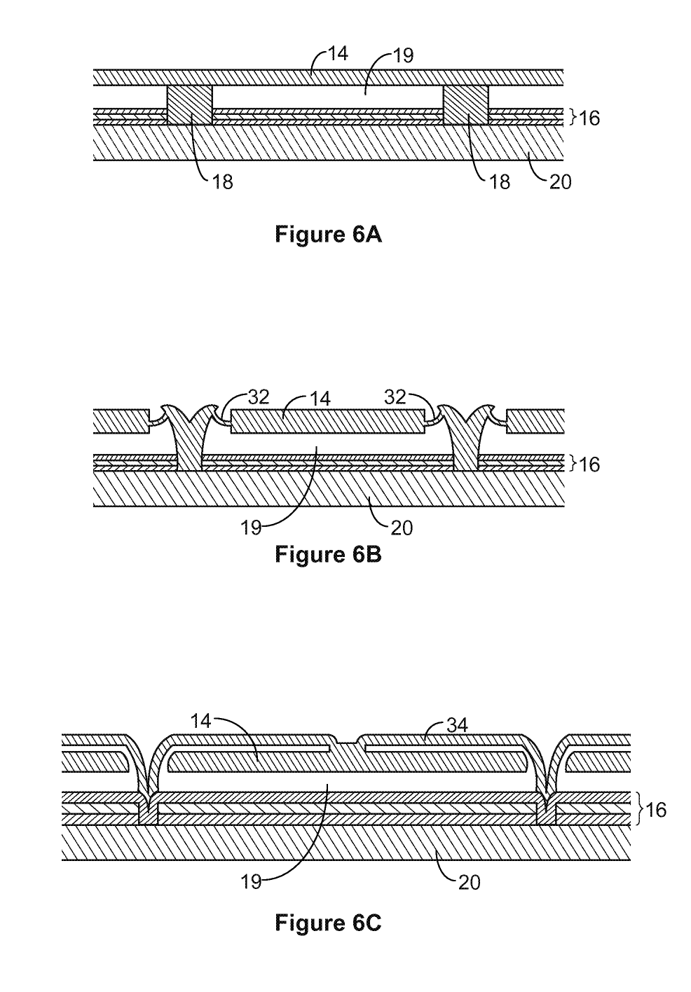

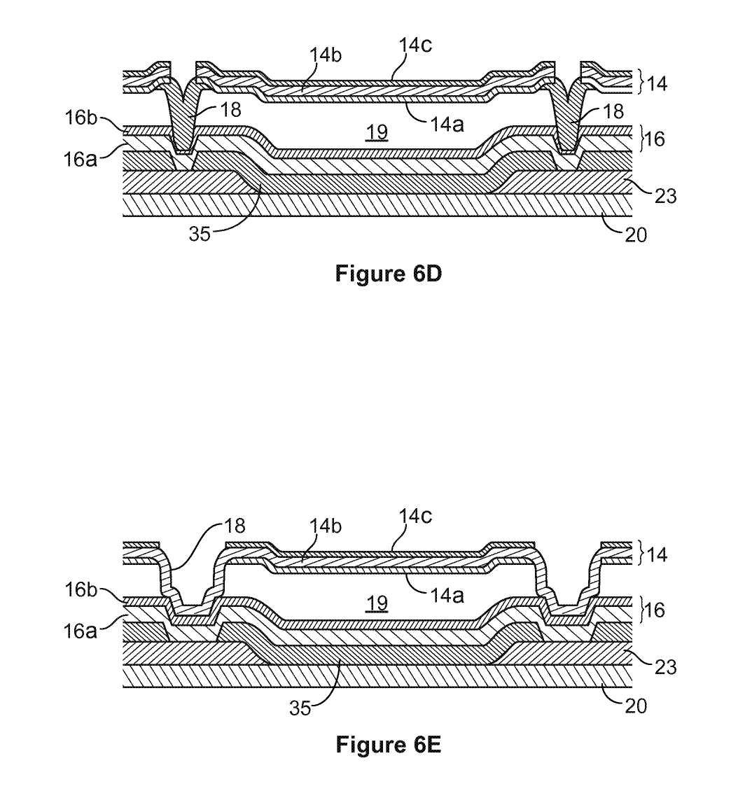

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

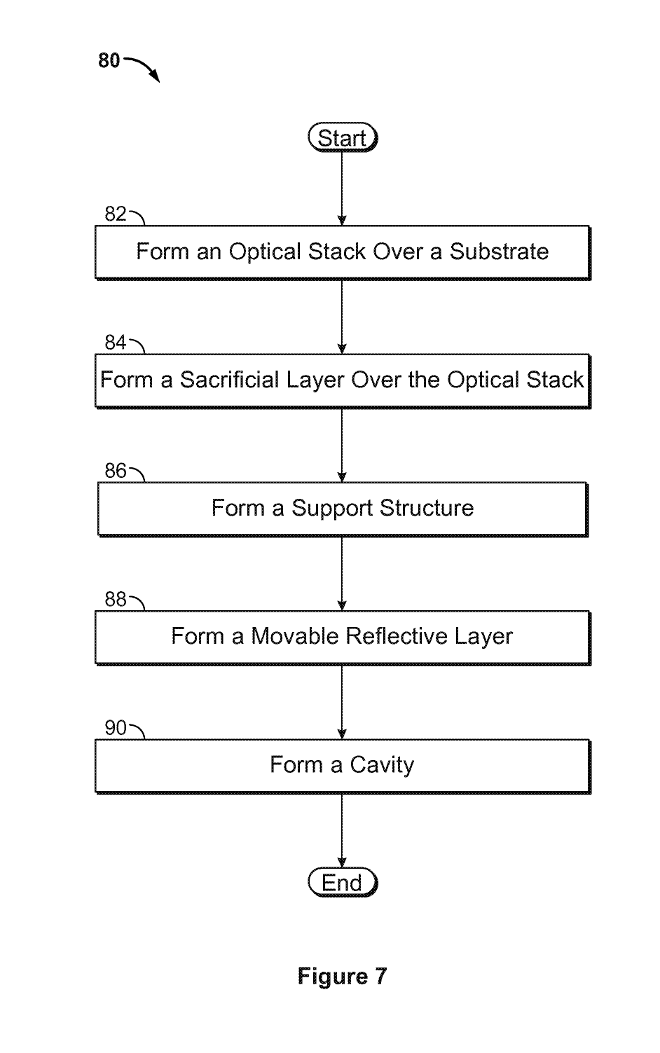

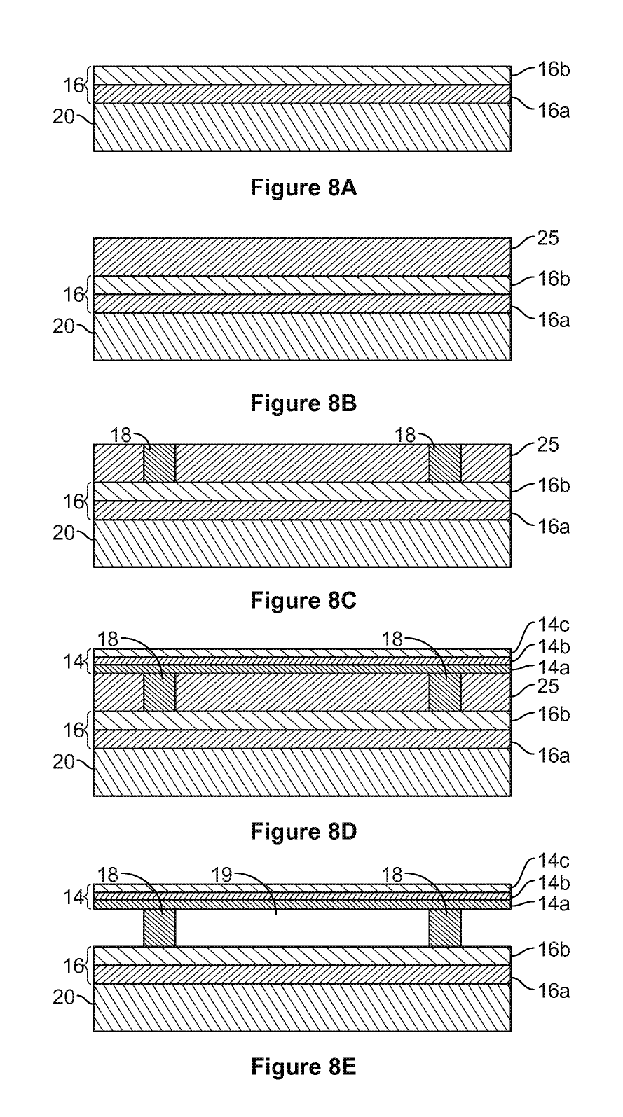

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning to remove portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

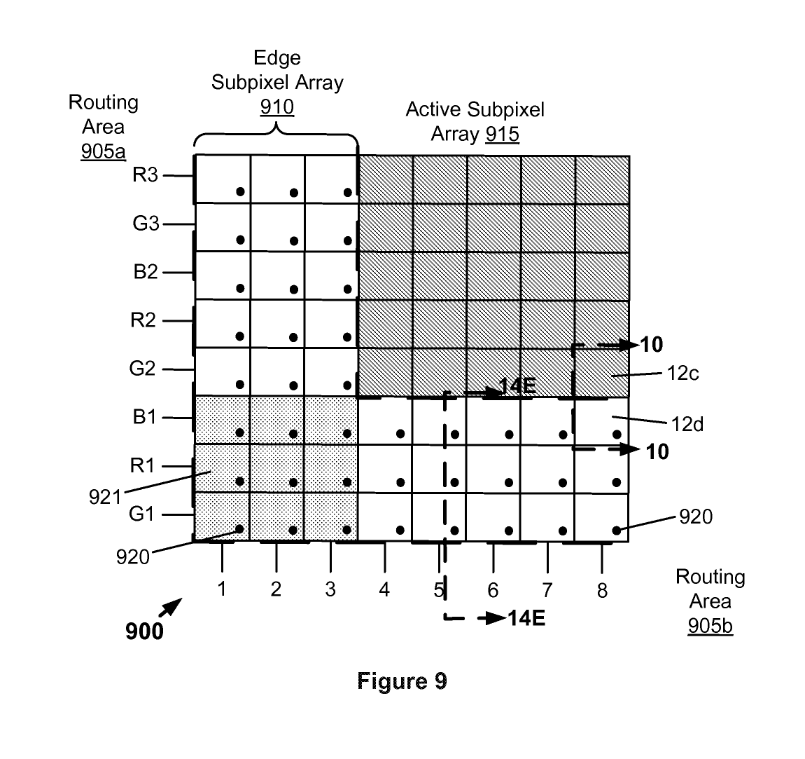

FIG. 9 shows an example of a display that includes an edge subpixel array having vias as provided herein. In this example, each row includes subpixels of the same type. For example, the bottom row illustrates red subpixels 1 through 8. The edge subpixel array 910 provides electrical connectivity between the routing area 905 and the active subpixel array 915. In this example, the active subpixel array 915 is formed of the interferometric modulators 12c, which may be substantially similar to those described above with reference to FIG. 1 or 6A through 6E.

In some implementations, the rows G1, R1 and B1 are not driven. Similarly, the columns 1 through 3 may not be driven. Instead, the nine “corner” subpixels 921 in this area may all be interconnected. This configuration may result in a significant voltage change at the interface between the edge subpixel array 910, the corner subpixels 921 and the active subpixel array 915, e.g., between the edge subpixels B1 and G2 in column 3, because the drive signals for driving the active subpixel array 915 are going through the edge subpixel G2. The routing area 905a, through which relatively large drive voltages are applied, may sometimes be referred to herein as the “common.” Relatively smaller drive voltages are applied in the routing area 905b, which is also known as the “segment.” In earlier implementations, the relatively large voltages that were applied in the common routing area actuated the edge subpixels that were disposed between the common routing area and the active subpixel array. This caused some power to be consumed pointlessly and caused other problems, such as needless complication of the drive schemes.

In order to address these problems, in the implementation shown in FIG. 9 the edge subpixel array 910 is formed of interferometric modulators 12d, each of which includes a via 920. Such configurations prevent interferometric modulators 12d from actuating. However, the configuration shown in FIG. 9 is merely an example. In alternative implementations, only one of edge subpixels 12d in each row or column includes a via 920. In some implementations, the corner subpixels 921 may not include a via 920. Other implementations may include subpixels active configured to produce different colors, may include different numbers of subpixels per pixel, may include more or fewer of the edge subpixels 12d between the routing areas 905 and the active subpixel array 915, etc.

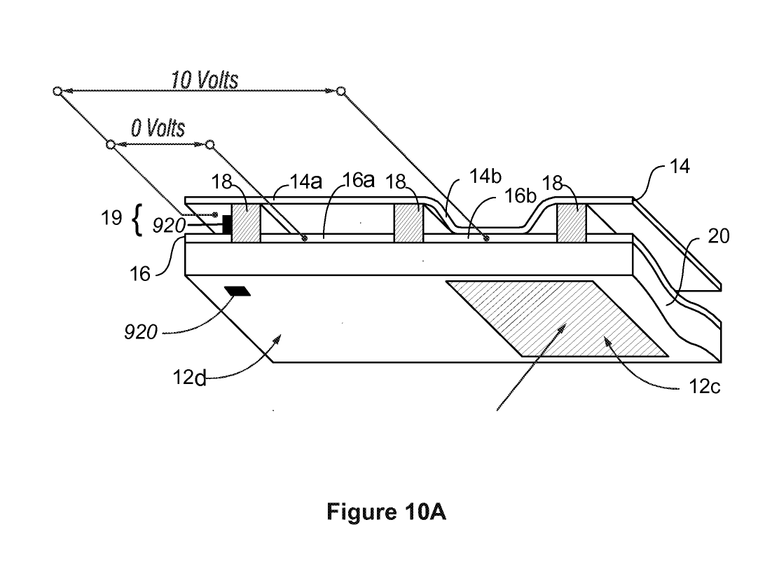

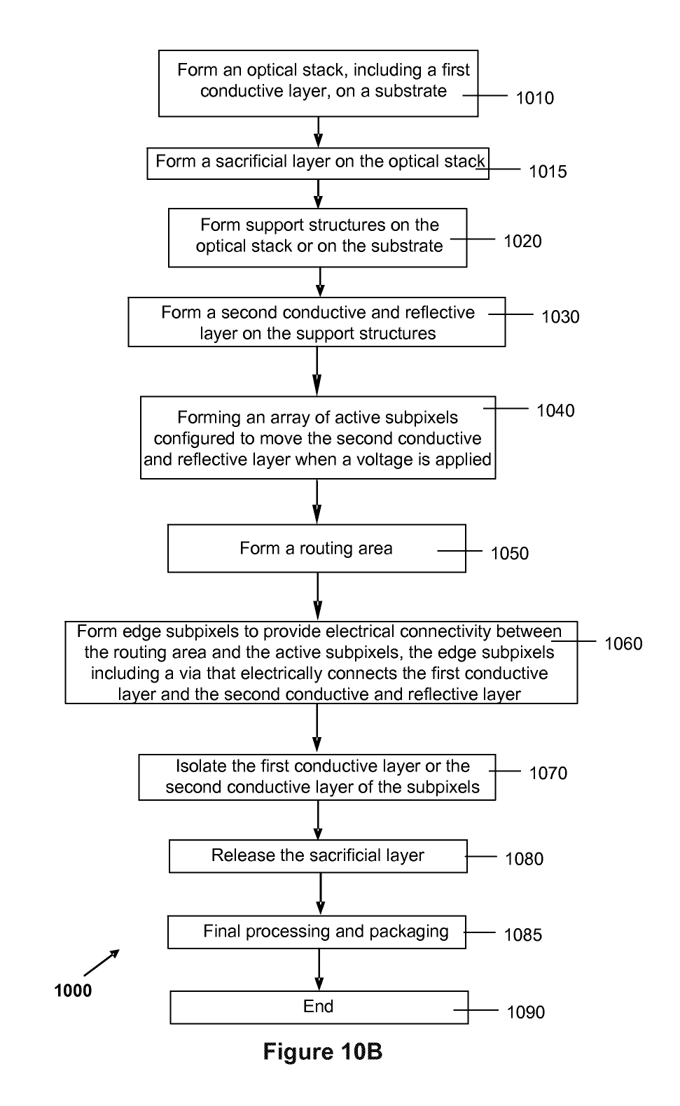

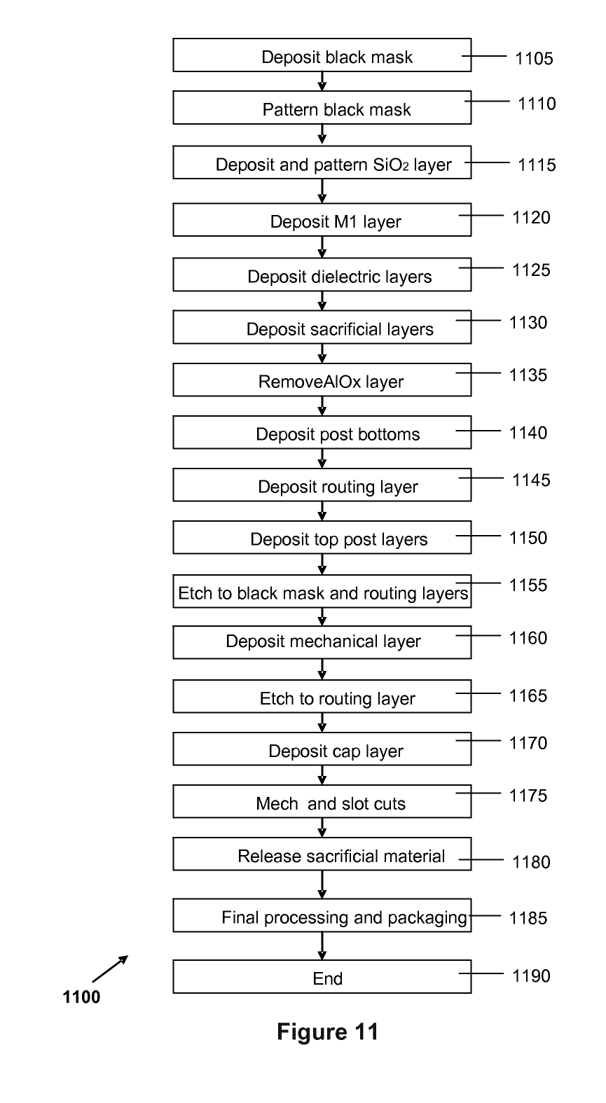

FIG. 10A shows an example of an isometric view depicting two adjacent subpixels in an IMOD display device. The orientation of FIG. 10A may be determined by reference to the dashed lines on the right side of FIG. 9. As shown in FIG. 9, the subpixel 12d of FIG. 10A is part of the edge subpixel array 910 and the subpixel 12c of FIG. 10A is part of the active subpixel array 915. The vias 920 connect the movable reflective layer 14 with the optical stack 16 of the interferometric modulator 12d. In this implementation, the vias 920 are positioned near the posts 18. In alternative implementations, such as those described below with reference to FIGS. 10B and 11, the vias 920 may be formed within at least some of the posts 18 in the edge subpixel array 910.

Because the vias 920 connect the movable reflective layer 14 with the optical stack 16 of the interferometric modulators 12d, the interferometric modulators 12d do not consume power when the active area is being driven. Moreover, the vias 920 may be made from material that has a higher electrical conductivity than the materials used to form the electrical connections between conventional edge subpixels or between the interferometric modulators 12c of the active subpixel array 915. Therefore, the edge subpixels 12d that include the vias 920 can conduct electric current more effectively between the routing area 905 and the active subpixel array 915 than conventional edge subpixels.

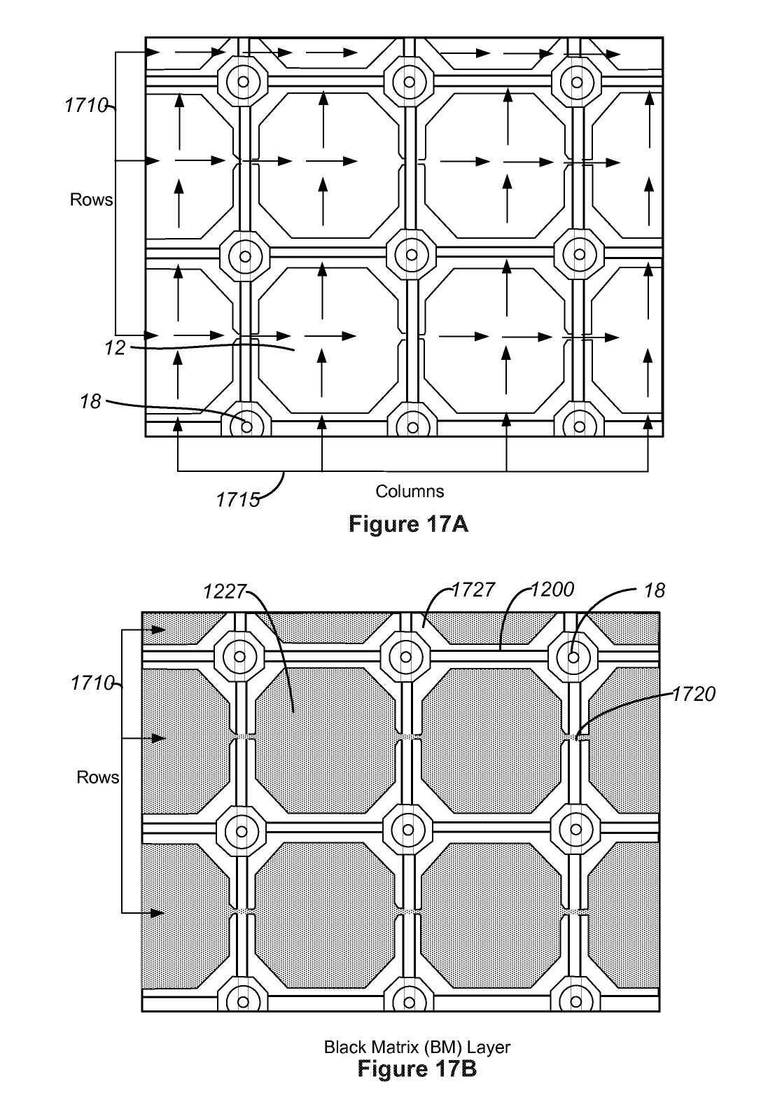

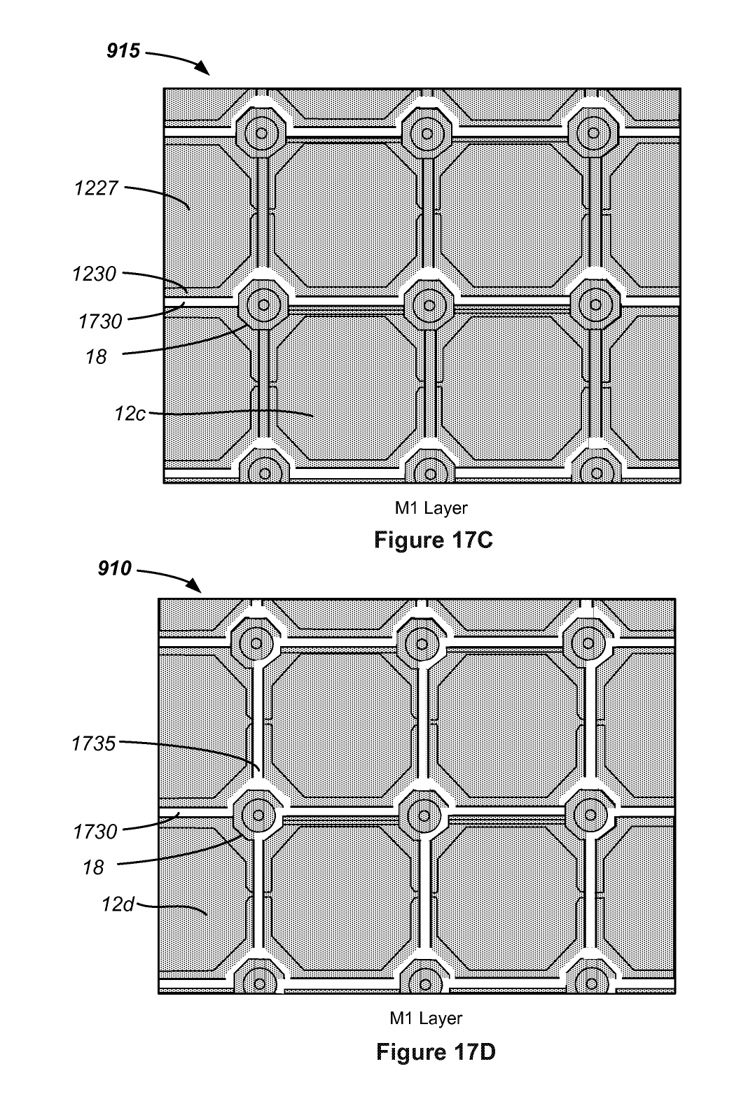

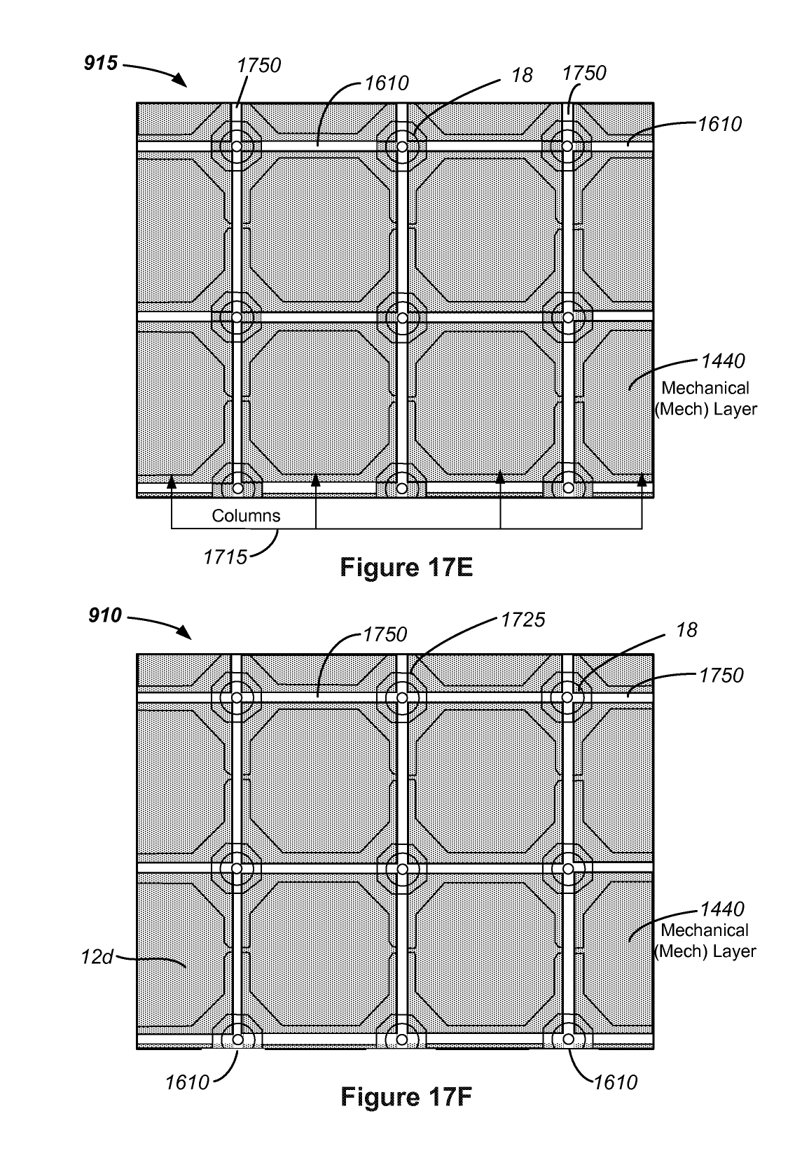

If the subpixels 12d having the vias 920 are electrically isolated, the rows and columns used for electrically connecting the routing areas 905a and 905b to the active subpixel array 915 can be maintained. In order to maintain electrical isolation of these rows and columns of the edge subpixel array 910, either the movable reflective layer 14 or the optical stack 16 of each interferometric modulator 12d may be isolated from that of the adjacent edge subpixels 12d. For example, the edge subpixels 12d along the rows that connect the routing area 905a with the active subpixel array 915 may include longer “slot cuts” than the edge subpixels 12c of the active subpixel array 915, in order to isolate adjacent portions of the movable reflective layer 14. Such slot cuts may extend across the posts 18 and connect the mech cuts, as described below with reference to FIGS. 17A through 17D.

FIG. 10B shows an example of a flow diagram illustrating a process of fabricating displays according to some implementations provided herein. Process 1000 will be described briefly and at a high level. More detailed examples are set forth below with reference to FIGS. 11 through 17F. The blocks of process 1000, like those of other processes described herein, are not necessarily performed in the order indicated. Alternative implementations of process 1000 may involve more or fewer blocks than are shown in FIG. 10B.

In block 1010, an optical stack is formed on a substantially transparent substrate. FIG. 10A illustrates one example of an optical stack 16 formed over a substrate 20. The substrate 20 may be a transparent substrate such as glass or plastic. In this example, the optical stack 16 is partially transparent and partially reflective, and includes a first conductive layer. The optical stack 16 may be fabricated, for example, by depositing one or more layers having the desired properties onto the transparent substrate 20.

In block 1015 of process 1000, one or more sacrificial layers are formed on the optical stack. The sacrificial layer is later removed (at block 1080) to form a cavity. Therefore, the sacrificial layer is not shown in FIG. 10A.

In block 1020 of FIG. 10B, support structures are formed on the optical stack 16. Block 1020 may involve forming a post 18 such as that as illustrated in FIG. 10A. The formation of the post 18 may include patterning the sacrificial layer to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer and the optical stack 16 to the underlying substrate 20, so that the lower end of the post 18 contacts the substrate 20 as illustrated in FIG. 10A. Alternatively, as depicted in FIG. 8C, the aperture formed in the sacrificial layer may extend through the sacrificial layer, but not through the optical stack 16.

In block 1030, a second conductive and reflective layer is formed on the support structures. One example of the second conductive layer is the layer 14 of FIG. 10A. The layer 14 may be formed by employing one or more deposition processes, along with one or more patterning, masking, and/or etching processes. In some implementations, the layer 14 may include a plurality of sub-layers.

Although blocks 1040, 1050 and 1060 are shown as sequential blocks in FIG. 10B, in some implementations they may be performed at substantially the same time. For example, blocks 1040, 1050 and 1060 may be performed as the corresponding features are formed on different areas of a substrate at substantially the same time. In block 1040, an array of active subpixels is formed. Active subpixel array 915 of FIG. 9 provides an example of one such array. Active subpixel array 915 may be composed of subpixels 12c, which may be similar to the subpixel 12c of FIG. 10A. The subpixels 12c may be configured to move the layer 14 when a voltage is applied between the layer 14 and the layer 16.

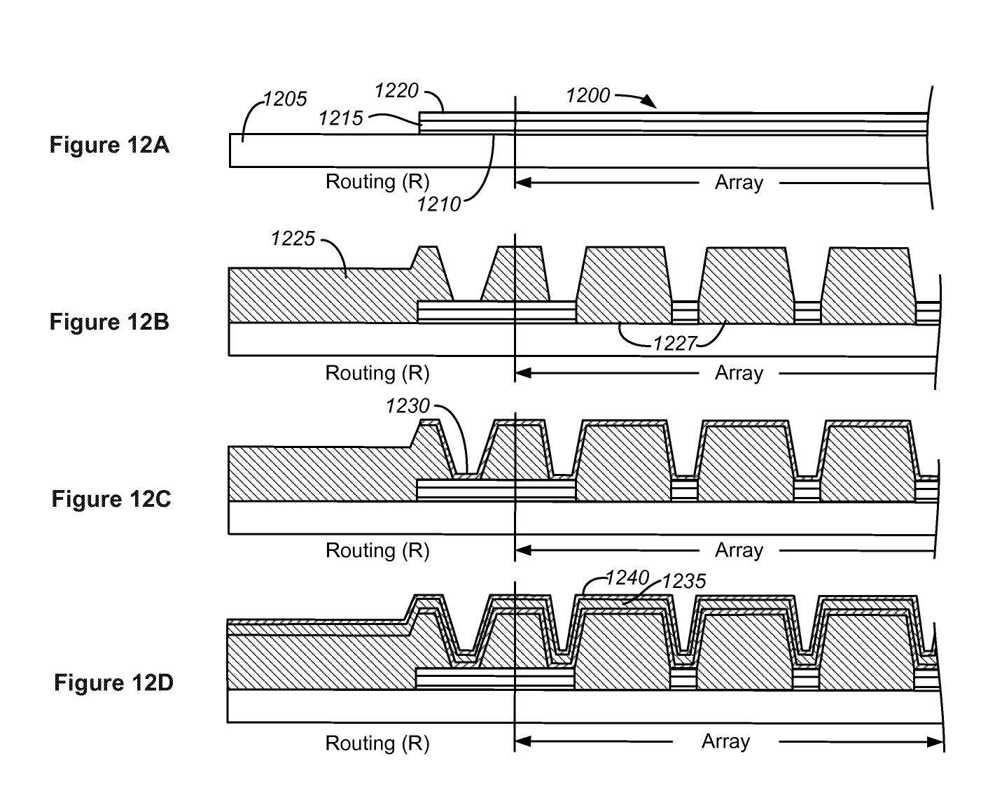

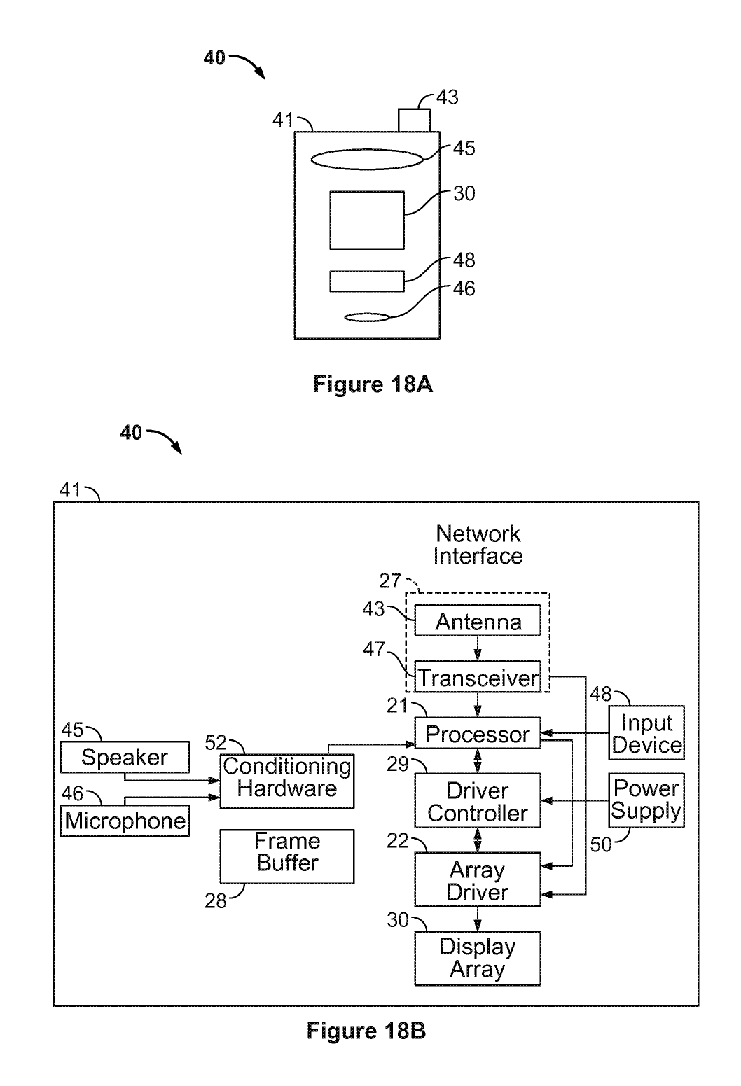

In this example, a routing area is formed in block 1050. The routing area may be used supply power and to connect various devices, such as those described below with reference to FIGS. 18A and 18B, to the subpixel array. The routing area may be similar to routing areas 905a and 905b that are shown in FIG. 9 and described in more detail below with reference to FIGS. 12A through 16C.

In block 1060, edge subpixels are formed. These edge subpixels may be configured to provide electrical connectivity between the routing area and the active subpixels. In this example, at least some of the edge subpixels include a via that electrically connects the first conductive layer and the second conductive and reflective layer. The via may, for example, be similar to one of the vias 920 shown in the subpixels 12d of FIGS. 9 and 10A. In some implementations, the vias may be formed near the posts 18 (see FIG. 10A). Some such implementations may involve, e.g., laser drilling and subsequent filling, e.g., by an electroplating process or by applying a conductive paste. In alternative implementations, such as those described below with reference to FIGS. 11 and 12A through 16C, the vias 920 may be formed within at least some of the posts 18 in the edge subpixel array 910.

In block 1080, the sacrificial layer is released to form an optical cavity between the optical stack 16 and the reflective and conductive layer 14. In the subpixels 12c of the active subpixel array, the reflective and conductive layer 14 of each active subpixel may be configured to be movable relative to the optical stack 16 when a sufficient voltage is applied between the first conductive layer and the second conductive layer.

In block 1085, final processing and packaging operations may be performed. For example, individual displays may be singulated. Processors, driver controllers, etc., may be electrically connected with the routing area. The resulting display devices may be incorporated into a portable device, e.g., a device such as that described below with reference to FIGS. 18A and 18B.

Some methods of device fabrication will now be described with reference to FIGS. 11 through 17F. FIG. 11 shows an example of a flow diagram that outlines a process of forming an array of subpixels for an interferometric modulator device. FIGS. 12A through 16C show examples of cross-sections through a subpixel array and routing elements during various stages in the process outlined in FIG. 11. FIGS. 17A through 17F show examples of various layers that may be used for routing in edge subpixels and active area subpixels. Accordingly, the following description will describe particular examples of the blocks of FIG. 11 with reference to FIGS. 12A through 17F.

In block 1105 of FIG. 11, a black mask 1200 is deposited on a substantially transparent substrate 1205 (see FIG. 12A). In some implementations, the black mask 1200 may be substantially similar to the black mask structure 23, which is described above with reference to FIG. 6D. The black mask 1200 can provide various functions in the displays described herein. One function of the black mask 1200 is to block light from certain areas of a display. For example, a subpixel of an interferometric modulator display generally has a post in each corner. As described and illustrated elsewhere herein, a column of subpixels may be mechanically and electrically isolated from the adjacent columns by cutting the mechanical or “mech” layer, which includes the reflective micromirrors of the interferometric modulator display. It is not desirable to have light reflecting from the post or other support structures. Therefore, the black mask 1200 may be disposed underneath the posts and other areas, such as the mech cuts, underneath other cuts known as “slot cuts,” etc. The black mask 1200 also may be used to block light from the “bending region” of the mechanical layer near the posts, which is not flat when the mechanical layer is activated.

In this example, a thin etch stop (Al₂O₃) layer is deposited first. This etch stop layer is not illustrated in FIG. 12A. A partially reflective molychrome (MoCr) layer 1210 may be deposited on the etch stop layer. Some light will reflect from the molychrome layer 1210. An oxide layer 1215 (which is SiO₂ in this example) may then be deposited, after which a reflective and conductive layer 1220 may be deposited. In this example, the layer 1220 is an AlSi layer, which is thick enough to be almost completely reflective. The thickness of the layer 1215 may be such that visible light reflected from the AlSi layer 1220 destructively interferes with the partially reflected light from the molychrome layer 1210.

However, it is desirable to have light reflecting from the remaining portions of the interferometric modulator display. Therefore, in block 1110, the black mask 1200 is patterned and removed from these “active areas” 1227. Block 1110 also may involve forming gaps 1720 in the black mask 1200, e.g., as depicted in FIG. 17B. These gaps 1720 may be formed in accordance with a second function of the black mask 1200, which is to form part of the circuitry of the subpixel array. The gaps 1720 may be formed in the black mask 1200 to electrically isolate rows of the black mask 1200 from one another. The black mask 1200 may be sufficiently conductive to convey signals, in the form of changes in voltage, to the subpixels 12c and/or groups of the subpixels 12c in the active subpixel array 915 (see FIG. 9). Accordingly, in some implementations the black mask 1200 may form a portion of what may be referred to herein as the “electrodes” in the edge subpixel array 910 and the active subpixel array 915.

In block 1115 of FIG. 11, an SiO₂ layer 1225 may be deposited and then vias may be etched through the SiO₂ layer 1225 to the AlSi layer 1220 (see FIG. 12B). A partially conductive and partially reflective layer 1230, which is another molychrome layer in this example, may then be deposited (see FIG. 12C and block 1120 of FIG. 11). The layer 1230, which may sometimes be referred to herein as the “M1” layer, also can form a portion of the electrodes in the subpixel array in some implementations. The M1 layer 1230 also may form a partial reflector for the active subpixel array 915 (see FIG. 9).

As described in more detail below, in some implementations “mech cuts” divide the mechanical layer into columns (see, e.g., FIGS. 17E and 17F). These mech cuts may mechanically and/or electrically isolate columns of conductive material in the mechanical layer. In some such implementations, the above-described row electrodes may form the other main part of the electrode system (see, e.g., FIGS. 17A and 17C). If a voltage is applied to a column and a row, a subpixel 12c (or a group of subpixels 12c) in the active subpixel array 915 will be driven: the coincident application of voltages pulls the mechanical layer's mirror down in that subpixel 12c. When the mirror is in this position, interference between light reflected from the subpixel's mirror and light reflected from the molychrome layer can make the subpixel appear black to a human observer.

In such implementations, the row electrodes include a layer 1230, which is a thin layer of molychrome in this example. The layer 1230 may be referred to herein as the M1 layer 1230. In some instances, the layer 1230 may be on the order of 50 angstroms thick. Molychrome is a relatively high-resistance material. Accordingly, the vias that are formed down to the conductive AlSi layer 1220 of the black mask 1200 in block 1115 effectively increase the overall conductivity of the overlying M1 layer 1230. Therefore, electrical signals may be carried across many pixels, e.g., from one routing side of the subpixel array to the other side of the subpixel array via this conductive AlSi layer 1220 of the black mask 1200. If M1 layer 1230 is connected to the conductive AlSi layer 1220 of the black mask 1200 in the vias adjacent to each subpixel, the higher-resistance layer 1230 may be used to convey electrical signals from the edge of the subpixel to the center of the subpixel. This distance may be made small enough that the signal transmission time associated with transmission through the layer 1230 can be kept within acceptable limits.

In this example, dielectric layers 1235 and 1240 are then deposited on the M1 layer 1230 (see block 1125 of FIG. 11 and FIG. 12D). Here, the layer 1235 is composed of SiO₂ and the layer 1240 is composed of aluminum oxide. In this example, the layers 1235 and 1240 form part of the optical gap that will control the color and the dark state of each subpixel 12c in the active subpixel array 915. Light that enters the bottom of the stack from the substantially transparent substrate 1205 will be partially reflected from, and partially transmitted by, the layer 1230.

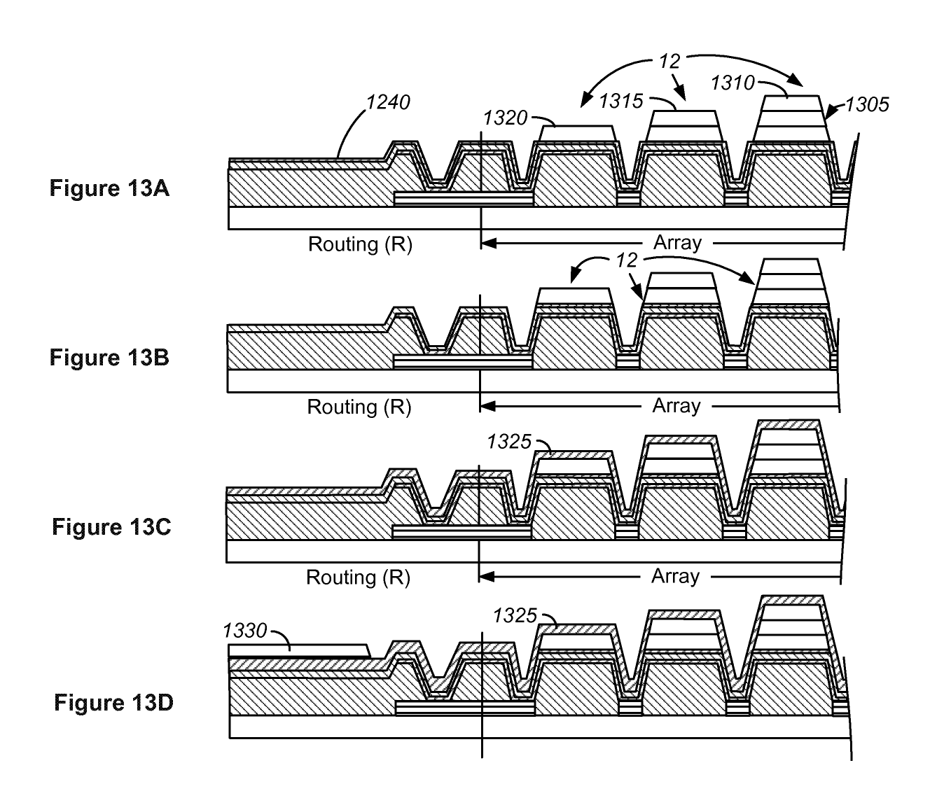

In order to form subpixels 12 that can produce three different colors, subpixels having optical cavities of three different sizes may be formed. In block 1130 of FIG. 11, for example, differing amounts of a sacrificial material 1305 are deposited to form each subpixel type (see FIG. 13A). Any suitable sacrificial material may be used, such as molybdenum. In order to form the deepest optical cavities 1310, three sacrificial layers are deposited. In this example, the subpixels 12 having optical cavities 1310 (which may be referred to herein as “high gap” subpixels) are configured to produce a second-order blue color. Second-order colors are more saturated, though not as bright as first-order colors. Here, a single layer of the sacrificial material 1305 is deposited in the thinnest (“low gap”) optical cavities 1320, which allow the subpixels 12 to produce a green color. In this example, two layers of the sacrificial material 1305 are deposited to form the “mid gap” optical cavities 1315, which are configured to produce a red color. Here, layers of the sacrificial material 1305 are deposited one at a time. Photo-patterning is completed on one layer before the next layer of the sacrificial material 1305 is deposited.

In block 1135, the layer 1240 is removed from areas outside of the subpixels in this example (see FIG. 13B). Bottom post material 1325 may then be deposited (see block 1140 and FIG. 13C). In this example, the bottom post material 1325 is formed from two layers, a lower layer of SiO₂ and an upper layer of silicon oxynitride (SiON). In block 1145, a conductive layer 1330 is deposited in the routing area outside of the subpixel array (see FIG. 13D). The layer 1330, which is formed of AlSi in this example, reduces the resistance of the peripheral routing and makes it easier for signals from the control circuitry to reach the subpixel array.

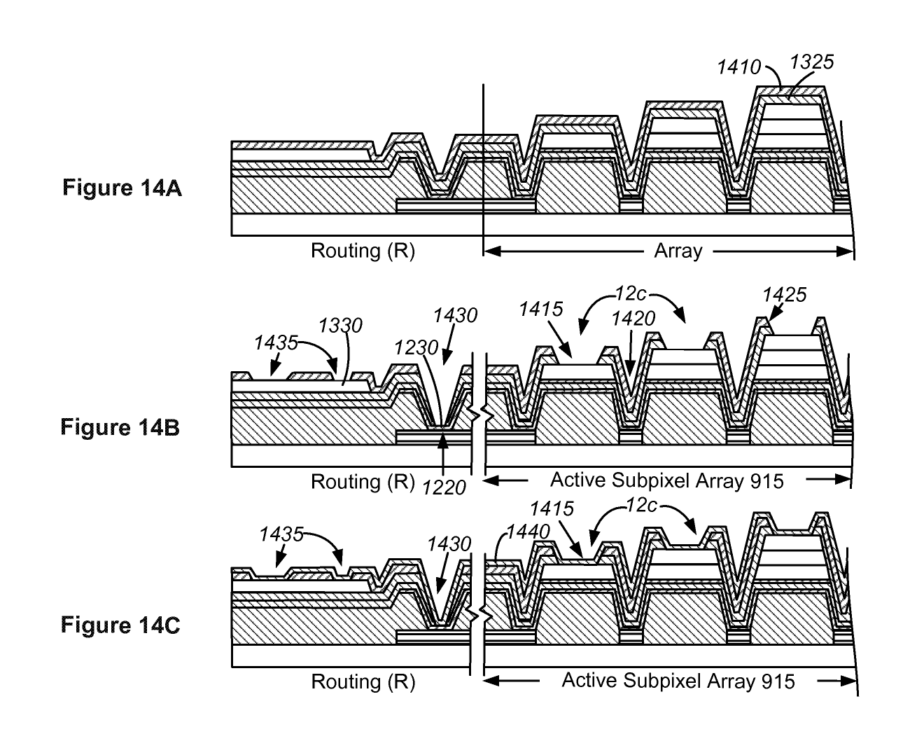

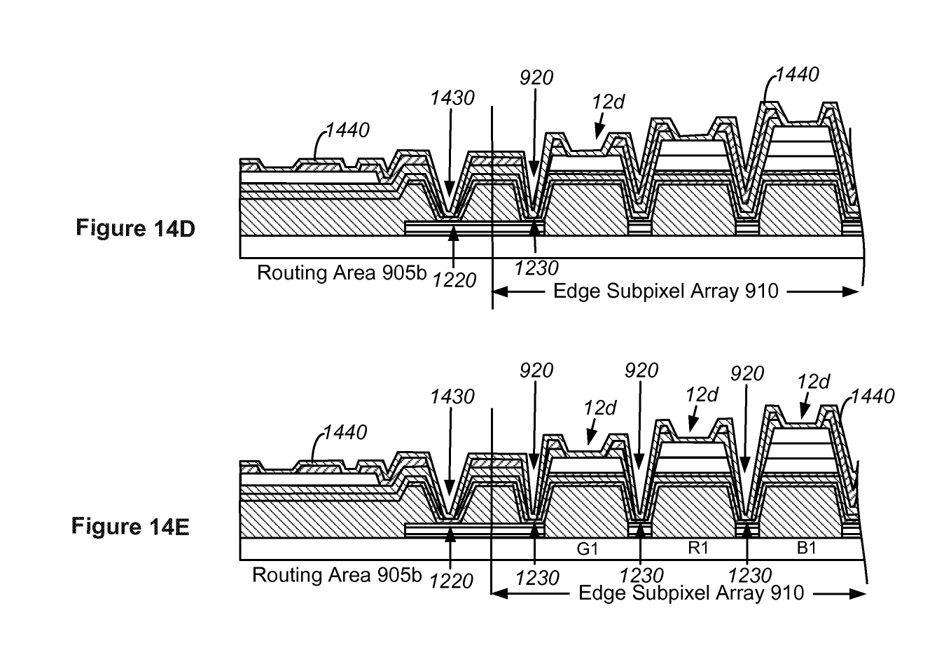

The top post material 1410 may then be deposited in block 1150 (see FIG. 14A). Like the bottom post material 1325, the top post material 1410 includes a layer of SiON and a layer of SiO₂ in this example.

In a via 1430 of the routing area, material may be removed down to M1 layer 1230, which overlies the reflective and conductive layer 1220 of the black mask 1200 (see FIG. 14B and block 1155 of FIG. 11). Here, the vias 1435 are formed down to the conductive layer 1330 in other portions of the routing area.

Block 1155 may involve a variety of other operations, according to the particular implementation and according to what part of the subpixel array is being formed. In order to form active subpixels 12c, the top post material 1410 and the bottom post material 1325 may be removed from areas 1415 of the subpixels 12c (see FIG. 14B). In this implementation, the “column” portions of the posts 1420 remain between the subpixels 12. The partially overlapping portions 1425 of the posts 1420 may be referred to herein as the “wings.”

A layer of reflective and conductive material 1440 may then be deposited in block 1160 (see FIG. 14C). In this example, the layer 1440 is made of an aluminum alloy. The layer 1440 forms a movable mirror in each of the areas 1415 of the active subpixels 12c. Moreover, the layer 1440 may then be configured for electrical connectivity with the vias 1430 and 1435.

However, in order to form dummy edge pixels as provided herein, block 1155 may involve alternative operations. In some such implementations, at least one via 920 may be formed in block 1155. In the example shown in FIG. 14D, a single via 920 is formed in the depicted cross-section through the routing area 905b and the edge subpixel array 910 (see also FIG. 9). Like the via 1430 formed in the routing area 905b, the via 920 allows the reflective and conductive layer 1440 to be configured for electrical connectivity with the M1 layer 1230. Such configurations prevent the interferometric modulator 12d from actuating, because there is no potential (voltage) difference between the mechanical layer (which includes layer 1440) and the M1 layer 1230. The effect of via 920 may be extended across multiple interferometric modulators 12d of the edge subpixel array 910 according to the connectivity of the layer 1440, the M1 layer 1230 and the black mask layer 1200 between edge subpixels, as will be discussed in more detail below with reference to FIGS. 17A through 17F.

In alternative implementations, block 1155 may involve forming vias 920 in each one of the interferometric modulators 12d of the edge subpixel array 910. FIG. 14E shows another example cross-section through the routing area 905b and the edge subpixel array 910. The location and orientation of this cross-section is shown in FIG. 9. In this implementation, a via 920 is formed in each one of the G1, R1 and B1 subpixels of the edge subpixel array 910 (see FIG. 14E). When the reflective and conductive layer 1440 is deposited in block 1160, the layer 1440 is configured for electrical connectivity with the M1 layer 1230 in each of the vias 920.

The mechanical layer may include not only the reflective and conductive layer 1440 but also overlying dielectric material. In addition to the layer 1440, this overlying dielectric material also may be deposited and patterned in block 1160.

In some implementations, substantially the same voltage is applied to all three types of subpixels 12c in the active subpixel array 915 (see FIG. 9). Although this is not a necessary feature, such implementations can simplify the control circuitry. In the high gap subpixels 12c there is a greater separation between the M1 layer and layer 1440. Therefore, a smaller electrical force will result from a given voltage. In some implementations, the stiffness of the mechanical layer of the high gap subpixels 12c is therefore configured to be less than that of the other subpixel types, so that less force is required to pull down the mechanical layer of the high gap subpixels 12c. Similarly, the stiffness of the mechanical layer of the low gap subpixels 12c may be configured to be greater than that of the other subpixel types, so that it is relatively harder to pull down the mechanical layer. Such configurations allow the actuation voltage for all three types of subpixels to be substantially equalized.

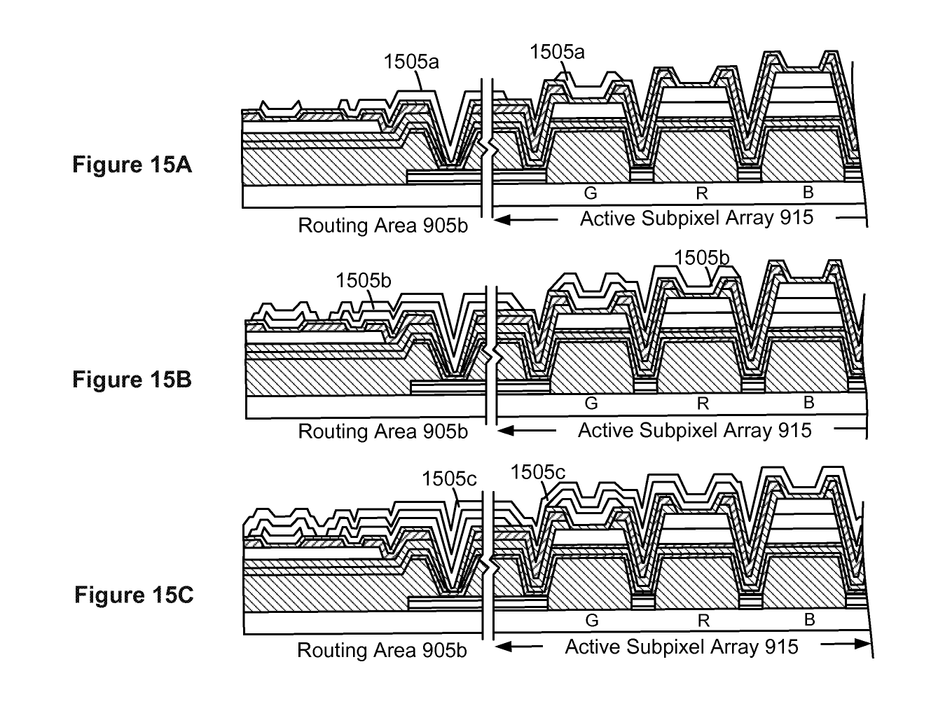

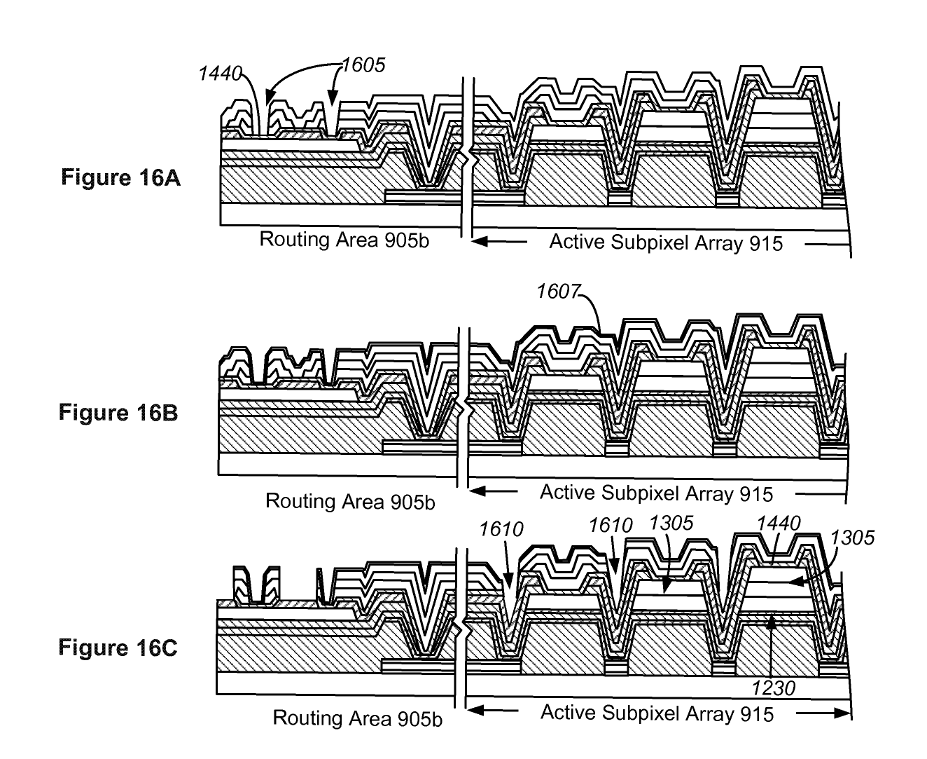

The mechanical layer for a green, low gap subpixel 12c can be made the stiffest by adding the dielectric layers 1505a, 1505b and 1505c to the reflective layer 1440 in the process of block 1160 (see FIGS. 15A, 15B and 15C). In this example, the material used to form the dielectric layers 1505a, 1505b and 1505c is SiON (silicon oxynitride), but other appropriate materials may be used. The mechanical layer for a mid gap, red subpixel 12c may be made moderately stiff by depositing the layers 1505b and 1505c on the reflective layer 1440 in block 1160 (see FIGS. 15B and 15C). The mechanical layer for a high gap, blue subpixel 12c may be made the least stiff by applying only the layer 1505c on the reflective layer 1440 in block 1160 (see FIG. 15C). In block 1165, the vias 1605 may be formed through the layers 1505a, 1505b and 1505c to the conductive layer 1440. (See FIG. 16A.)

In block 1170 of FIG. 11, a cap layer 1607 is deposited over the dielectric layer 1505c to complete the mechanical layer structure in this example (see FIG. 16B). The cap layer 1607, which is an aluminum alloy in this example, helps the mechanical layer to be more symmetrical. The coefficient of thermal expansion is different for aluminum than it is for SiON. If there is aluminum (or another reflective metal) on the bottom of the mechanical layer and only dielectric above the aluminum, the structure will tend to deform: when the mechanical layer is cooled to room temperature, the aluminum will tend to contract more than the dielectric and will tend to “bow up” the membrane. A curved mirror will tend to produce a range of colors instead of a single color. However, if the mechanical layer is formed in a more a symmetrical fashion, with metal layers at the top and bottom, the aluminum layers will exert an approximately equal pull on the top and the bottom of the structure. Therefore, the forces will tend to cancel out, which produces a flatter mirror.

In block 1175, the mech cuts and slot cuts are formed (see FIG. 16C). The mech cuts and the slot cuts 1610 are formed in order to isolate the rows and columns of subpixels. In this example, the slot cuts 1610 pass through the plane of FIG. 16C. The mech cuts are not shown on FIG. 16C, as they are formed in planes that are substantially parallel to that of FIG. 16C in this implementation. The mech cuts and the slot cuts 1610 may both be seen in FIGS. 17E and 17F.

FIGS. 17A through 17F show examples of top down views in a plane that is substantially orthogonal to those of FIGS. 12A through 16C. FIG. 17A depicts substantially square subpixels 12 arranged in rows 1710 and columns 1715. The rows 1710 and columns 1715 shown in FIG. 17A provide more details regarding one example of the rows and columns shown in FIGS. 2 and 5A and described above. The posts 18 are disposed in the corners of the subpixels 12.

The black mask 1200 and the active areas 1227 may be seen in FIG. 17B. The black mask 1200 is primarily disposed on the edges of the active areas 1227, in order to allow light into and out of the subpixels 12 in the active areas 1227. The black mask 1200 is wider near the posts 18, in order to mask both the posts 18 and the bending regions 1727. Gaps 1720 are formed in black mask 1200 in order to electrically isolate the rows 1710 from one another.

However, as noted above, M1 layer 1230 is also involved in conducting electrical signals. FIG. 17C shows an example of how the rows of M1 layer 1230 may be separated from one another in the active subpixel array 915. In this example, the rows of M1 layer 1230 are separated from one another by etching gaps 1730 between the active areas 1227 and around the posts 18 of the subpixels 12c. Such configurations are also suitable for rows of edge subpixel array 910 that connect routing area 905a with active subpixel array 915 (see FIG. 9). In such areas of edge subpixel array 910, it is desirable to maintain the electrical connectivity of the M1 layer 1230 between adjacent subpixels 12d in each row.

FIG. 17D shows an example of how the rows and columns of the M1 layer 1230 may be separated from one another in areas of the edge subpixel array 910 that connect the routing area 905b with the active subpixel array 915. In this example, gaps 1735 separate each of the subpixels 12d from the adjacent subpixels 12d in each row. Such configurations may be desirable if there is a via 920 in each of the subpixels 12d of this area of the edge subpixel array 910. Because the vias 920 form an electrical connection between the M1 layer 1230 and the conductive layer 1440 of the mechanical layer, without the gaps 1735 the vias 920 would cause a short circuit between adjacent columns in these areas of the edge subpixel array 910.

FIG. 17E shows an example of how portions of the mechanical layer may be separated from one another in the active subpixel array 915.

FIG. 17E shows examples of the mech cuts 1750, which separate the columns 1715 of the conductive and reflective layer 1440 in this example. FIG. 17E also shows examples of the slot cuts 1610, examples of which are also shown in FIG. 16C and described above. The slot cuts 1610 extend horizontally between posts 18 in this example. In the active subpixel array 915 (and in that portion of the edge pixel array 910 that connects the routing area 905b with the active subpixel array 915), the slot cuts 1610 do not extend over the posts 18 in this implementation. Accordingly, the conductive layer 1440 may be made continuous in the columns 1715, in order to connect the routing area 905b with the active subpixel array 915.

FIG. 17F shows an example of how portions of the mechanical layer may be separated from one another in some areas of the edge subpixel array 910. In this implementation, the slot cuts 1610 extend over the posts 18. The vias 920 form an electrical connection between the M1 layer 1230 and the conductive layer 1440 of the mechanical layer. Therefore, if the slot cuts 1610 did not extend over the posts 18, the vias 920 would cause a short circuit between adjacent rows in these areas of the edge subpixel array 910.

After the slot cuts 1610 and the mech cuts 1750 are formed in block 1175, the sacrificial material 1305 may be released in block 1180 (see FIG. 11 and FIG. 16C). Releasing sacrificial material 1305 forms air gaps between the M1 layer 1230 and the reflective and conductive layer 1440. The depth of each air gap will correspond to the peak wavelength of light that has been selected for constructive interference between light reflected from the reflective layer 1440 and light partially reflected from the M1 layer 1230. In the active subpixel array 915, the mechanical layer can be moved within this air gap from an open position, in which the color of each subpixel 12c will be produced, to a closed or “dark” position (see FIG. 10A).

In block 1185, final processing and packaging operations may be performed. For example, individual displays may be singulated. Processors, driver controllers, etc., may be electrically connected with the routing area. The resulting display devices may be incorporated into a portable device, e.g., a device such as that described below with reference to FIGS. 18A and 18B.

FIGS. 18A and 18B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. The processor 21 may be configured to receive time data, e.g., from a time server, via the network interface 27.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

For example, the concepts described herein could be applied to almost any type of passively-addressed display that has dummy pixels, such as passively-addressed organic light-emitting diode (OLED) displays or passively-addressed field emission displays. If the passively-addressed display has pixel-like edge structures outside the active area and is a two-terminal device, for example, vias could be formed in the pixel-like edge structures. The concepts described herein may be very useful in OLEDs for various reasons, including power and wear issues. It would be desirable to include OLED edge pixels in order to avoid edge process effects. It would also be desirable for OLED edge pixels to be completely dark, which could be accomplished by forming dummy pixels generally as described herein.

The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A passively-addressed display, comprising:
a routing area;
an active subpixel array including rows and columns of active subpixels;
an edge subpixel array including rows and columns of edge subpixels, the edge subpixels configured to provide electrical connectivity between the routing area and the active subpixels, each of the edge subpixels and the active subpixels including a first conductive layer and a second conductive layer; and
at least one of the edge subpixels in each row or column further including a via configured to provide electrical connectivity between the first conductive layer and the second conductive layer.

2. The display of claim 1, wherein each of the edge subpixels and the active subpixels further include a plurality of posts disposed between the first conductive layer and the second conductive layer, and wherein the via is disposed proximate the post.

3. The display of claim 1, wherein each of the edge subpixels and the active subpixels further include a plurality of posts disposed between the first conductive layer and the second conductive layer, and wherein the via is formed in at least one of the posts in each row and column of edge subpixels.

4. The display of claim 1, wherein the second conductive layer of each active subpixel is configured to be movable relative to the first conductive layer when a sufficient voltage is applied between the first conductive layer and the second conductive layer.

5. The display of claim 1, wherein the edge subpixels and the active subpixels include electromechanical systems (“EMS”)-based devices.

6. The display of claim 1, wherein the display is an organic light-emitting diode (“OLED”) display or a field emission display.

7. The display of claim 1, wherein the first conductive layer is configured to provide electrical connectivity between a row or a column of active subpixels.

8. The display of claim 1, wherein the second conductive layer is configured to provide electrical connectivity between a row or a column of active subpixels.

9. The display of claim 4, wherein the second conductive layer is formed of a reflective material.

10. The display of claim 1, further comprising:
a processor that is configured to communicate with the display, the processor being configured to process image data; and
a memory device that is configured to communicate with the processor.

11. The display of claim 10, further comprising:
a driver circuit configured to send at least one signal to the display; and
a controller configured to send at least a portion of the image data to the driver circuit.

12. The display of claim 10, further comprising:
an image source module configured to send the image data to the processor.

13. The display of claim 12, wherein the image source module includes at least one of a receiver, transceiver, and transmitter.

14. The display of claim 10, further comprising:
an input device configured to receive input data and to communicate the input data to the processor.

15. A method, comprising:
forming an optical stack over a substrate, the optical stack including a first conductive layer;
forming a plurality of support structures on the optical stack or on the substrate;
forming a second conductive and reflective layer on the support structures;
forming an array of active subpixels that include the first conductive layer, the support structures and the second conductive layer such that the second conductive and reflective layer is movable between a first position and a second position when a voltage is applied to the active subpixels;
forming routing area outside the array of active subpixels; and
forming an edge subpixel array including rows and columns of edge subpixels, the edge subpixels configured to provide electrical connectivity between the routing area and the active subpixels, each of the edge subpixels including the first conductive layer, the second and reflective conductive layer and the support structures, at least one of the edge subpixels in each row or column further including a via configured to provide electrical connectivity between the first conductive layer and the second conductive and reflective layer.

16. The method of claim 15, further comprising:
isolating the first conductive layer or the second conductive and reflective layer of adjacent edge subpixels.

17. The method of claim 15, wherein the process of forming the edge subpixel array includes forming the vias in the support structures of the edge subpixels.

18. The method of claim 15, wherein the process of forming the edge subpixel array includes forming the vias proximate the support structures of the edge subpixels.

19. The method of claim 15, wherein the process of forming the edge subpixel array includes forming a via in each edge subpixel.

20. The method of claim 15, wherein the second conductive and reflective layer of the edge subpixels is not configured to be movable when the edge subpixels provide electrical connectivity between the routing area and the active subpixels.

21. A passively-addressed display, comprising:
routing means;
a plurality of active subpixel means including a first conductive layer and a second conductive and reflective layer, the active subpixel means including means for controlling an optical cavity by moving the second conductive and reflective layer from a first position to a second position; and
edge subpixel means for providing electrical connectivity between the routing means and for providing electrical connectivity between the first conductive layer and the second conductive layer.

22. The display of claim 21, wherein each of the edge subpixel means and the active subpixel means include a plurality of posts disposed between the first conductive layer and the second conductive and reflective layer, and wherein the means for providing electrical connectivity between the first conductive layer and the second conductive and reflective layer comprises a via formed in at least one of the posts in each row and column of edge subpixels.

23. The display of claim 21, wherein the edge subpixel means and the active subpixel means include electromechanical systems (“EMS”)-based devices.

24. The display of claim 21, wherein the display is an organic light-emitting diode (“OLED”) display or a field emission display.

25. The display of claim 21, wherein the first conductive layer is configured to provide electrical connectivity between a row or a column of active subpixels.
